(19) United States
(12) Patent Application Publication
(10) Pub. No.: US 2023/0010135 A1
(43) Pub. Date: Jan. 12, 2023

(54) COIN TRAY SET

(71) Applicant: Benjamin Allen Wallace, King George, VA (US)

(72) Inventor: Benjamin Allen Wallace, King George, VA (US)

(21) Appl. No.: 17/809,776

(22) Filed: Jun. 29, 2022

Related U.S. Application Data
(60) Provisional application No. 63/220,140, filed on Jul. 9, 2021.

(51) Int. Cl. G07D 9/06

(52) U.S. Cl. CPC G07D 9/065

(57) ABSTRACT

A disk counting and wrapping set includes a first tray and a second tray. The first tray has a first rectangular planar base with upstanding sidewalls extending to form a first longitudinal semi-cylindrical trough with a transverse sidewall at each end. The first trough precisely accommodates a stacked predetermined number of a disk having a predetermined diameter. Both troughs have the same diameter. The second tray has a second base with upstanding sidewalls extending to form a second trough with a transverse sidewall at a one end. The other end of the trough accepts a coin roll sleeve. The second trough has a length greater than that of the first trough. The set is used by placing coins individually into the first tray until the first trough is full. Placing the second tray snugly over the coins; the trays are axially rotated, and the first tray is removed.

### CROSS-REFERENCE TO RELATED APPLICATION

This application claims the benefit of priority of U.S. provisional application No. 63/220,140, filed Jul. 9, 2021, the contents of which are herein incorporated by reference.

### BACKGROUND OF THE INVENTION

The present invention relates to an apparatus for counting and wrapping coins and, more particularly, to a coin tray set.

Individuals, coin hobbyists, and low coin volume businesses require a simple, quick, reliable, and low one-time cost solution to create proper bank coin rolls to organize and store coins, deposit them, or exchange them for paper currency. One common manual technique to ensure the correct number of coins is to arrange the coins in a 4×10 or 5×8 array for coin rolls requiring 40 coins, a 5×10 array for coin rolls requiring 50 coins, etc. Errors such as losing count of the coins and having to restart the count or putting too few or too many coins in the paper wrapper also increases the time devoted to assembling a proper coin roll.

Commercial coin redemption services charge a standard redemption fee such as 11.9 percent of the value of coins submitted. Moreover, they are prone to miscounts. Consumer testing has identified error rates near 18 percent. These services are also disadvantageous due to the inconvenience of traveling to the machine's location. Machines providing this service may be inoperative when needed.

Mechanical and electro-mechanical coin sorting and wrapping systems are expensive and take up space. System components frequently jam or wear out. Vertical rolling tubes are cumbersome. Electro-mechanical sorting and wrapping machines are expensive, costing about $200-$1,500 and more.

As can be seen, there is a need for a simple, quick, reliable, and low-cost apparatus to create bank coin rolls acceptable to financial institutions.

### SUMMARY OF THE INVENTION

In one aspect of the present invention, a disk counting and wrapping set comprises a first tray having a first rectangular planar base with upstanding sidewalls extending therefrom to form a first longitudinal semi-cylindrical trough with a transverse sidewall at each end, wherein the first longitudinal semi-cylindrical trough is dimensioned to precisely accommodate a predetermined number of a selected disk having a predetermined diameter, in a stacked configuration; and a second tray having a second rectangular planar base with upstanding sidewalls extending therefrom to form a second longitudinal semi-cylindrical trough dimensioned to accommodate the predetermined diameter; said second longitudinal semi-cylindrical trough having a transverse sidewall at a first end of the trough, with a second end of the trough configured to slidably accommodate a coin roll sleeve having the predetermined diameter; wherein the second longitudinal semi-cylindrical trough has a length greater than that of the first longitudinal semi-cylindrical trough.

In another aspect of the present invention, a method of counting and wrapping coins comprises providing the disk counting and wrapping set; placing coins individually into the first tray until the first longitudinal semi-cylindrical trough is full; placing the second tray snugly over the coins; rotating together axially the first tray and the second tray; removing the first tray from the coins; inserting a paper sleeve into the second end of the second tray, along the second longitudinal semi-cylindrical trough and around the coins; centering the coins within the paper sleeve; and crimping a first end and a second end of the paper sleeve.

These and other features, aspects and advantages of the present invention will become better understood with reference to the following drawings, description, and claims.

### BRIEF DESCRIPTION OF THE DRAWINGS

FIG. 1 is a perspective view of a coin rolling apparatus according to an embodiment of the present invention;

FIG. 2 is a perspective view of a coin tray thereof, shown in use;

FIG. 3 is another perspective view thereof, shown in use;

FIG. 4 is another perspective view of the coin rolling apparatus of FIG. 1, shown in use;

FIG. 5 is another perspective view thereof, shown in use;

FIG. 6 is another perspective view thereof, shown in use;

FIG. 7 is a sectional view thereof, taken along line 7-7 in FIG. 6;

FIG. 8 is another perspective view thereof;

FIG. 9 is another perspective view thereof; and

FIG. 10 is a perspective view of a coin rolling set according to an embodiment of the present invention, including the coin rolling apparatus of FIG. 1.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a pair of coin trays with a semi-cylindrical interior, both having an identical internal diameter selected to be slightly larger than that of the coin to be wrapped. “Counting” and “wrapping” trays may be provided for any coin minted throughout the world as well as for coin-like items such as arcade game tokens, gambling casino tokens, and coin-like collectibles.

The inventive system greatly reduces the time required to manually make accurate bank coin rolls from loose coins from minutes to seconds. It has no moving parts that may jam and wear out, it can be used at the user's home or place of business, and it is far less expensive than other coin sorting and wrapping systems. The invention ensures a correct coin count, needs no calibration, and has no recurring consumer costs. The inventive system provides the greatest time benefits when both components are used together. Considerable time may still be saved using either component individually.

The invention decreases the time to manually create bank coin rolls acceptable by financial institutions or other businesses. It virtually eliminates losing count of or miscounting the number of coins to be inserted into paper wrappers and the time it takes to recount them. While ensuring the correct number of coins are present, the “counting” tray provides a considerable time advantage over the coin array method.

The internal length of a fitted “counting” tray is precisely dimensioned to hold a predetermined number of coins selected for a commercially available paper coin wrapper (e.g., 40 coins for U.S. Jefferson nickels and U.S. Washington quarters, 50 coins for U.S. Lincoln pennies and U.S. Roosevelt dimes, 20 coins for U.S. Kennedy half dollars, and 25 coins for U.S. state dollars, etc.). The “counting” tray eliminates the need to count the correct number of coins to assemble a bank coin roll acceptable to a financial institution. The “counting” tray stops the user from losing count or miscounting the number of coins to fill a coin roll.

A mated “wrapping” tray is longer than the “counting” tray and open on one end to permit effortless insertion of a paper wrapper slipped laterally over the coins. The open-ended “wrapping” tray securely holds the coins in a lateral position.

Both trays may have flat bases to rest on level surfaces.

The invention may be manufactured using 3D printer(s). Other methods of manufacture may be used to accommodate higher production rates. The material of manufacture is not particularly limited provided each tray is easy to clean, keeping the work area free of dirt.

A method of using the invention comprises identical steps regardless of the coin or coin-like item being wrapped. The user may select a coin size to be wrapped and a corresponding “counting” tray fitted to the coins to be wrapped. The user may fill the “counting” tray with coins and place a mated “wrapping” tray securely over the coins and against the “counting” tray. By flipping both trays together, the user effortlessly transfers the coins from the “counting” tray to the “wrapping” tray. Removing the “counting” tray reveals the coins stacked vertically in the “wrapping” tray. The user may select a paper wrapper fitted for the coins to be wrapped. The user may laterally slip the empty paper coin wrapper around the coins contained in the “wrapping” tray. The user may remove the paper wrapper and the coins in it from the “wrapping” tray. Regardless of whether one or both trays is used, the user may center the coins in the paper wrapper, then crimp both ends of the paper wrapper to complete the coin roll. Everything can be done with one hand! The rolled coins may be stored, deposited, or exchanged.

When using the “counting” tray alone, the user may select the paper wrapper corresponding to the coin type to be wrapped, remove the coins from the “counting” tray and insert them into the paper wrapper until all the coins from the “counting” tray are in the paper wrapper.

Using only the “wrapping” tray, the user may count the correct number of coins to be placed in the corresponding paper wrapper. The user may place the counted coins in the “wrapping” tray. The user may laterally slip the paper coin wrapper over the coins contained in the “wrapping” tray. The user may then remove the paper wrapper and the coins in it from the “wrapping” tray, center the coins, and crimp the ends of the wrapper.

In some embodiments, the trays may be color-coded to correlate with predetermined colors of paper coin wrappers for easy identification (i.e., a mated counting tray and wrapping tray will have the same color).

Alternate embodiments may dramatically improve the success of individuals with limited hand dexterity, those missing an index finger, and even those missing a hand to manually assemble coin rolls.

In some embodiments, a knob or stub slightly less than the diameter of the coins being wrapped may be added to the closed end of the “wrapping” tray to allow the paper wrapper to be inserted beyond the first coin to automatically center the coins in the wrapper. The length of this knob or stub may be half the difference between the coin wrapper length and the length of the predetermined number of coins to be inserted. This embodiment may eliminate the need to insert index fingers in either end of the wrapper to position and center the coins, a particular benefit for individuals missing an index finger or those with index fingers wider than the paper wrapper (e.g., for the U.S. Roosevelt dimes).

In some embodiments, the two trays may be connected by a hinge to better ensure the trays do not separate.

In some embodiments, the “wrapping” tray base may be manufactured with a no-skid surface to prevent it from moving as it is used, improve one-handed use. In some embodiments, the denomination (e.g., 1 cent, 5 cents, etc.) and/or the coin's common name (e.g., penny, nickel, etc.) may be printed on either or both trays, e.g., to assist color-blind individuals. In some cases, the denomination and/or name may be printed in braille to assist blind individuals.

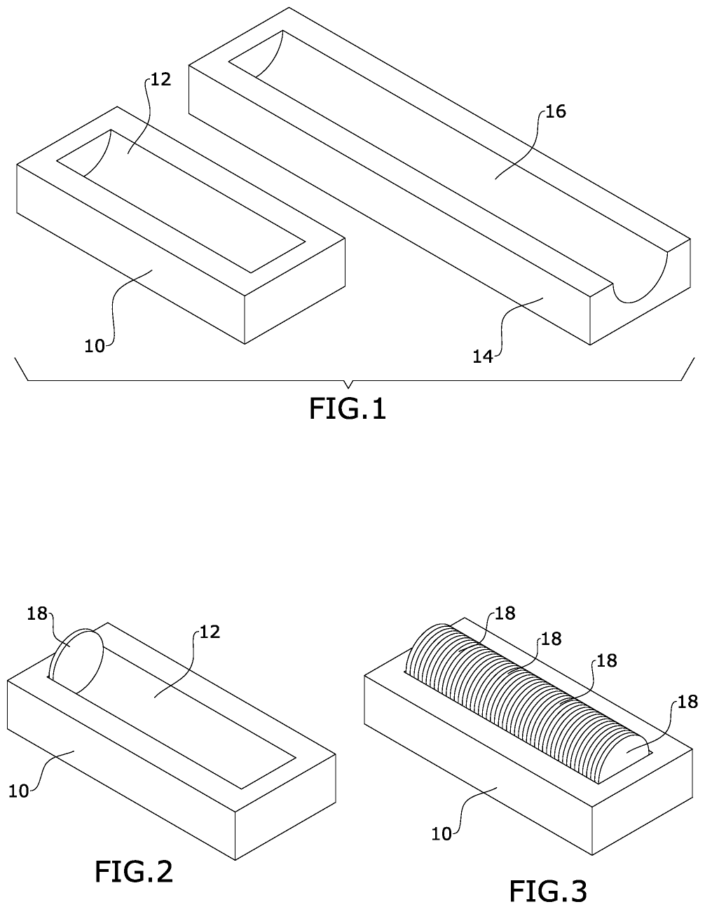

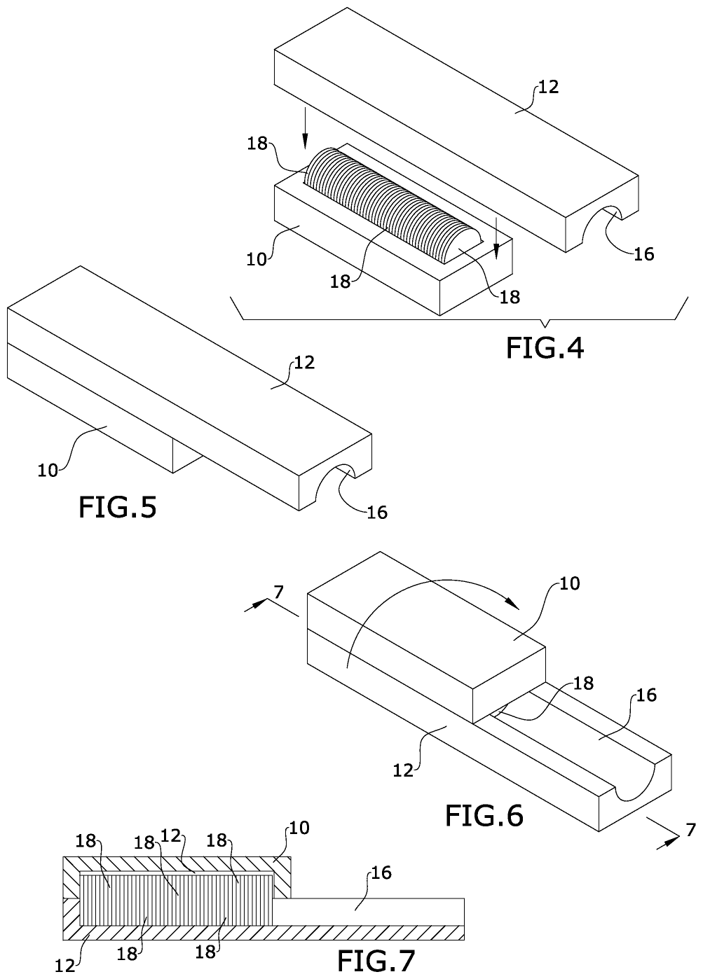

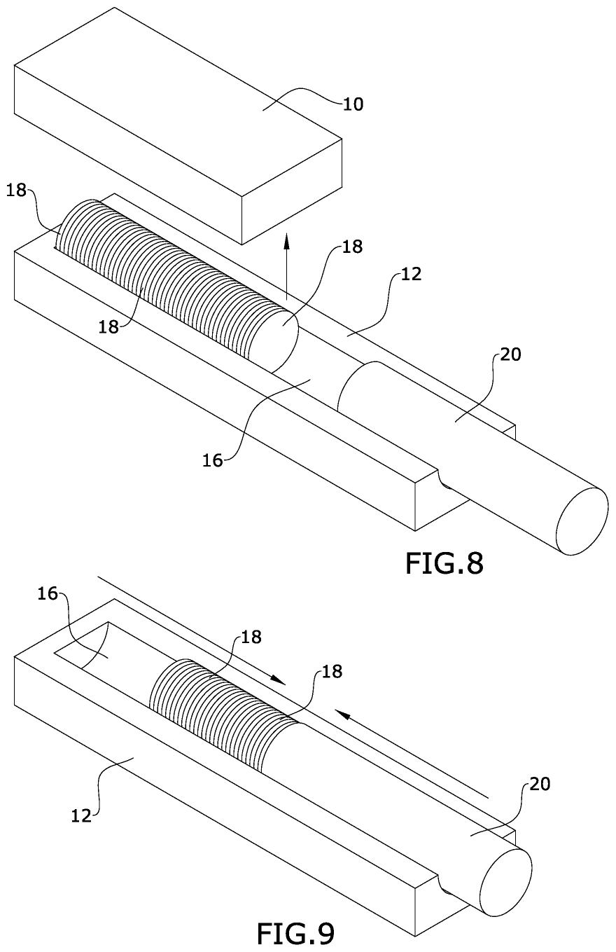

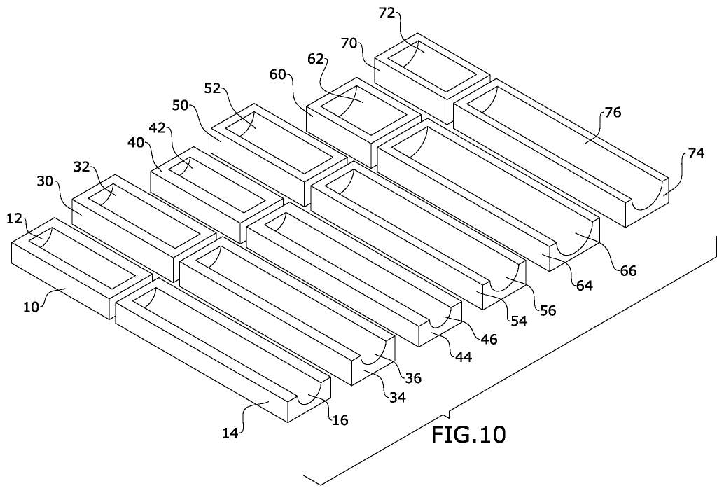

Referring to FIGS. 1 through 10, FIG. 1 illustrates a mated coin tray 10 and roll tray 14, dimensioned, for example, to accommodate pennies. Each tray 10, 14 has a coin slot 12, 16 having the same internal diameter. As shown in FIGS. 2-3, coins 18 may be individually placed into the coin tray 10 slot 12 until it is full. FIGS. 4-6 illustrate a step of placing the roll tray 14 snugly over the coins 18 in the coin tray 10 and flipping the trays 10, 14 together. As seen in FIG. 7, the coin tray 10 holds the stack of coins 18 at a closed end of the roll tray 14 slot 16. The coin tray 10 may be removed and a paper roll 20 may be inserted into the roll tray 14 slot 16, as shown in FIG. 8. The coins 18 may be simultaneously slid into the paper roll 20 until they are centered therein; see FIG. 9. FIG. 10 illustrates a set of mated trays dimensioned for U.S. coins, including the penny coin tray 10, the penny roll tray 14, a nickel coin tray 30 with a nickel coin slot 32, a nickel roll tray 34 with a nickel roll tray slot 36, a dime coin tray 40 with a dime coin slot 42, a dime roll tray 44 with a dime roll tray slot 46, a quarter coin tray 50 with a quarter coin slot 52, a quarter roll tray 54 with a quarter roll tray slot 56, a half dollar coin tray 60 with a half dollar coin slot 62, a half dollar roll tray 64 with a half dollar roll tray slot 66, a dollar coin tray 70 with a dollar coin slot 72, and a dollar roll tray 74 with a dollar roll tray slot 76.

It should be understood, of course, that the foregoing relates to exemplary embodiments of the invention and that modifications may be made without departing from the spirit and scope of the invention as set forth in the following claims.

What is claimed is:

1. A disk counting and wrapping set, comprising:
a first tray having a first rectangular planar base with upstanding sidewalls extending therefrom to form a first longitudinal semi-cylindrical trough with a transverse sidewall at each end, wherein the first longitudinal semi-cylindrical trough is dimensioned to precisely accommodate a predetermined number of a selected disk having a predetermined diameter, in a stacked configuration; and
a second tray having a second rectangular planar base with upstanding sidewalls extending therefrom to form a second longitudinal semi-cylindrical trough dimensioned to accommodate the predetermined diameter; said second longitudinal semi-cylindrical trough having a transverse sidewall at a first end of the trough, with a second end of the trough configured to slidably accommodate a coin roll sleeve having the predetermined diameter; wherein the second longitudinal semi-cylindrical trough has a length greater than that of the first longitudinal semi-cylindrical trough.

2. The disk counting and wrapping set of claim 1, wherein said upstanding sidewalls of the first rectangular planar base and said upstanding sidewalls of the second rectangular planar base terminate in mating first and second planar surfaces; and wherein the first planar surface of the first tray has a rectangular “O” shape and the second planar surface of the second tray has a rectangular “U” shape.

3. The disk counting and wrapping set of claim 1, wherein the first longitudinal semi-cylindrical trough and the second longitudinal semi-cylindrical trough form a cylinder when juxtaposed, said cylinder being dimensioned to accommodate a circumference of the selected disk.

4. The disk counting and wrapping set of claim 1, wherein the first tray and the second tray are accompanied by mated trays dimensioned for a plurality of disk diameters.

5. The disk counting and wrapping set of claim 1, wherein the plurality of disk diameters are correlated with coins selected from the group consisting of pennies, nickels, dimes, quarters, half dollars, dollars, and any combination thereof.

6. A method of counting and wrapping coins, comprising:
Providing the disk counting and wrapping set of claim 1;
placing coins individually into the first tray until the first longitudinal semi-cylindrical trough is full;
placing the second tray snugly over the coins;
rotating together axially the first tray and the second tray;
removing the first tray from the coins; inserting the coin roll sleeve into the second end of the second tray, along the second longitudinal semi-cylindrical trough and around the coins;
centering the coins within the coin roll sleeve; and
crimping a first end and a second end of the coin roll sleeve.
